(19) United States
(12) Patent Application Publication
(10) Pub. No.: US 2016/0271646 A1
(43) Pub. Date: Sep. 22, 2016

(54) Personal Care Apparatus Including An Ultraviolet Cured Coating

(71) Applicant: Spectrum Brands, Inc., Middleton, WI (US)

(72) Inventors: Michael deGrood, Madison, WI (US); Maciej Murzynski, Verona, WI (US)

(21) Appl. No.: 15/059,561

(22) Filed: Mar. 3, 2016

Related U.S. Application Data
(60) Provisional application No. 62/134,275, filed on Mar. 17, 2015.

(51) Int. Cl. B05D 3/06; A45D 24/00; A45D 20/12; A45D 1/06; A45D 2/00

(52) U.S. Cl. CPC B05D 3/067; A45D 1/06; A45D 2/001; A45D 20/12; A45D 24/00

(57) ABSTRACT

This disclosure relates to an ultraviolet cured coating on a personal grooming apparatus. The apparatus includes an ultraviolet cured composition coated on a substrate of the apparatus. The composition includes at least one additive that has been cured by ultraviolet light either before application to the substrate or while the coating is on the substrate. Other aspects of the present disclosure relate to methods for manufacturing the apparatus.

### CROSS-REFERENCE TO RELATED APPLICATIONS

This application claims priority to U.S. Provisional Patent Application Ser. No. 62/134,275 filed on Mar. 17, 2015, which is incorporated herein by reference in its entirety.

### FIELD OF THE DISCLOSURE

This disclosure relates to an ultraviolet cured personal grooming apparatus. The apparatus includes an ultraviolet cured coating composition on a substrate therein. The coating composition includes at least one additive that has been cured by ultraviolet light. Other aspects of the present disclosure relate to methods for manufacturing the apparatus.

### BACKGROUND OF THE DISCLOSURE

Personal care apparatus, such as hair styling devices, may typically include coating compositions deposited thereon or incorporated therein. These compositions can include a variety of elements and/or additives for treating hair.

These compositions are typically either sprayed on the apparatus or cured in an oven at an elevated temperature. Though these methods may provide for the coatings to be deposited on the apparatuses, the manufacturing cycle time for these methods generally takes a long time. Additionally, these methods can become expensive, particularly with respect to energy costs. Moreover, these methods generally produce a coating that may not have adequate hardness or toughness.

Accordingly, there remains a need in the industry of personal care apparatuses, particularly with respect to hair grooming devices, to provide a method of manufacturing a personal care apparatus having a coating deposited thereon (or incorporated therein) that has increased hardness, increased toughness, can reduce manufacturing cycle times and can reduce energy costs during manufacturing.

### SUMMARY OF THE DISCLOSURE

In some embodiments of the present disclosure, a method for manufacturing a personal care apparatus for grooming hair is disclosed. The method comprises curing at least one additive under ultraviolet (UV) light, mixing the at least one cured additive into a formulation to form a coating composition; and, applying the coating composition to a substrate of the apparatus.

In other embodiments of the present disclosure, a method for manufacturing a personal care apparatus for grooming hair is disclosed. The method comprises applying a coating composition to a substrate of the apparatus, the composition comprising at least one additive; and, curing the coating composition under ultraviolet (UV) light.

In yet other embodiments of the present disclosure, a personal grooming apparatus for grooming hair is disclosed. The apparatus comprises a substrate and a coating composition disposed on the substrate, wherein the coating composition comprises at least one additive that has been cured under ultraviolet (UV) light.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

FIG. 1 is an exemplary embodiment of a hair straightener with a UV cured coating disposed thereon in accordance with the present disclosure.

FIG. 2 is an exemplary embodiment of a curling iron with a UV cured coating disposed thereon in accordance with the present disclosure.

Corresponding reference characters indicate corresponding parts throughout the drawings.

### DETAILED DESCRIPTION

In accordance with the present disclosure, a personal grooming apparatus includes a coating on a surface thereof that incorporates one or more additives that have been cured by ultraviolet (UV) light. For purposes of the present disclosure, references to “UV” are synonymous with “UV light.” Further, for purposes of the present disclosure, “personal grooming apparatus” or “personal care apparatus” includes any item that is used to groom the hair of a user without limitation. Suitable apparatuses that groom the hair include, for example, hair straighteners, hair curlers, curling irons, hot rollers (synonymously “hot curlers”), brushes, combs, picks, devices for securing hair (hair ties, berets, etc.), hair clippers and hair razors (including the friction-reducing strips or pads incorporated into hair razors). In this regard, personal grooming apparatuses other than those listed above may be used without departing from the scope of the present disclosure.

The substrates to which the coating compositions of the present disclosure are applied are generally a surface which contacts the hair during use. For instance, the substrate may be the plates (e.g., aluminum or ceramic) of a hair straightener, the barrel of a curling iron, or the teeth or bristles of a comb or brush. In some embodiments, however, the substrate may be a grill in a hair dryer, or the inner components such as a heater assembly of a hair dryer.

Generally, the coating compositions of the present disclosure are capable of coating essentially any type of surface commonly used for a personal grooming apparatus, including substrates that are composed of metal (e.g., aluminum, low carbon or stainless steel alloys), ceramics (e.g., silica, alumina or silicon carbide) or thermoplastics (e.g., polymer materials). The coating compositions may also be applied directly to the surface or substrate of the apparatus, or to a base coating that has previously been formed or deposited on the substrate material.

Ultraviolet Light (UV) Curing

In accordance with the present disclosure, the inventors have found that UV light can be used to cure certain materials (e.g., additives). By curing the additives with UV light, the inventors have surprisingly been able to change the properties of certain additive materials, such as increasing the hardness, toughness and wear resistance of the additive materials.

These UV cured additive materials can then be mixed into a formulation to form a coating composition which can then be applied onto and/or into a personal care apparatus. Additionally, in other embodiments, the coating compositions including the additive materials can be cured with UV light after application to the personal care apparatus. In either approach, the resulting coating compositions have the increased hardness, toughness and wear resistance as a result of the UV curing process.

The inventors have found that UV curing has a number of benefits, including, but not limited to, reducing manufacturing cycle times and reducing energy costs in manufacturing. The UV curing process produces these beneficial results because, for example, the UV curing process has a quicker curing time than methods that are generally used in the industry. Not only can this lead to reduced cost during manufacturing, but the UV curing process also is able to beneficially produce coating compositions that have increased hardness, toughness and wear resistance. Additionally, another benefit of the UV curing process is that the coating compositions have an improved aesthetic appearance, including an improved shine to the coating.

The UV curing can be done to the additive material before the additive is mixed with a formulation to form a coating composition, and then the coating composition is applied to a substrate to form a coating, or, alternatively, the UV curing can be done to the entire coating composition after the additive has already been added. When the UV curing occurs after the additive is already part of the coating composition, the coating composition can then be cured either before, after, or during application of the coating composition to the personal care apparatus. In any approach, curing the additive material either before or after addition to the remainder of the coating composition will produce a coating composition that has increased hardness, increased toughness, improved shine, and increased wear resistance.

Accordingly, in some embodiments of the present disclosure, a method for manufacturing a personal care apparatus for grooming hair is disclosed. The method comprises curing at least one additive under UV light, mixing the at least one cured additive into a formulation to form a coating composition, and, applying the coating composition to a substrate of the apparatus.

In other embodiments, a method for manufacturing a personal care apparatus for grooming hair is disclosed. The method comprises applying a coating composition to a substrate of the apparatus, the composition comprising at least one additive and curing the coating composition under UV light.

The UV curing can be done in accordance with the present disclosure to achieve, for example, a desired hardness, wear resistance, toughness and/or shine. In accordance with the present disclosure, the wavelength of the UV light used for curing is adjusted based on the additive being cured or the total composition being utilized. For example, different additives will cure at different wavelengths of UV light. In some embodiments, the UV light used for curing has a wavelength of from about 100 nm to about 400 nm. In preferred embodiments, the UV light used for curing has a wavelength of from about 200 nm to about 400 nm, or from about 350 nm to about 400 nm. In other preferred embodiments, the UV light used for curing has a wavelength of from about 300 nm to about 375 nm.

In some embodiments, the at least one additive (and/or the coating composition) is cured under UV light from about 0 hours to about 2 hours. In preferred embodiments, the at least one additive (and/or the coating composition) is cured under UV light from about 1 minute to about 2 hours, from about 1 minute to about 15 minutes, or from about 5 minutes to about 15 minutes. In other preferred embodiments, the at least one additive (and/or the coating composition) is cured under UV light for at least about 5 minutes.

In accordance with the present disclosure, curing the at least one additive (and/or the coating composition) at the appropriate power level is beneficial because it reduces the curing time and thus reduces production time. Accordingly, in some embodiments, the at least one additive (and/or the coating composition) is cured under UV light at a power of from about 0 W/m² to about 2,000 W/m². In preferred embodiments, the at least one additive (and/or the coating composition) is cured under UV light at a power of from about 0 W/m² to about 1,500 W/m², from about 5 W/m² to about 1,000 W/m², or from about 5 W/m² to about 300 W/m². In other preferred embodiments, the at least one additive (and/or the coating composition) is cured under UV light at a power of at least about 5 W/m², at least about 300 W/m², or at least about 1,000 W/m².

The UV light can be generated from known UV light sources in the industry. For example, the UV light can be generated from a mercury vapor lamp, a fluorescent lamp or a UV LED light. In some preferred embodiments, the UV light is generated from a mercury vapor lamp. Mercury vapor lamps are very good at curing clear coatings and heavily pigmented coatings. In some embodiments, a mercury vapor lamp with iron (D type) is used to generate the UV light.

Coating Compositions

The personal care apparatuses of the present disclosure are generally prepared by applying a coating composition to a targeted surface of the apparatuses. In this regard, it should be understood that, as used herein, “coating compositions” refer to the composition that is applied to the substrate of the apparatus and not the coating itself which forms after additional processing steps (e.g., vaporization of solvent, heating, curing, sintering and the like). As used herein, the term “coating” refers to the material on the surface of the substrate after all processing steps are complete and is not meant to include any solvent and/or carrier that evaporates from the coating composition.

It is to be further understood that the benefits of the UV curing are present whether the curing has (1) occurred before mixing a cured additive with a formulation to form the coating composition; (2) occurred after the additive has been added to the coating composition; or (3) after the coating composition has been finally formed as the coating on the substrate. That is, the UV curing process can take place at various steps along the way during the manufacturing process and the benefits that result from UV curing will be present at each and every curing step.

In certain embodiments of the present disclosure, the coating composition contains a volatile carrier or solvent such as an alcohol that may be evaporated from the composition to form the “coating.” The percent inclusion of components of the “coating composition” as described below refer to the material applied to the substrate of the personal grooming apparatus; whereas, percent inclusion of the components of the “coating” refer to the solid material covering a portion of the substrate after all processing steps are complete.

Generally, the coating compositions of the present disclosure incorporate one or more UV additives for improvement of mechanical properties of the coating composition. As used herein, a “UV additive” is a material that has the ability to absorb ultraviolet light. In some embodiments, the coating composition comprises at least one additive, and the at least one additive comprises titanium dioxide. Titanium dioxide is a highly effective transparent UV absorber that can provide protection of the substrate that improves fracture toughness and bending modulus and thus is an exemplary UV additive in accordance with the present disclosure. Further, titanium dioxide is inorganic and can therefore be mixed and dispersed very well with a variety of coating types. An exemplary titanium dioxide in accordance with the present disclosure is HOMBITEC RM 110, from Sachtleben (Duisburg, Germany).

The at least one additive can be present in particulate form, and, more preferably, in ultra-fine particle form. In some embodiments, the at least one additive has a thickness of from about 0 mm to about 1 mm, preferably from about 0.001 mm to about 0.100 mm. In some embodiments, a minimum of about 0.1% of the at least one additive is present in the coating composition. In some embodiments, the coating composition comprises from about 0.1% to about 40% by weight of the at least one additive. In other embodiments, the coating composition comprises from about 0.1% to about 5% by weight of the at least one additive. In yet other embodiments, the coating composition comprises about 5% by weight of the at least one additive. It is important that the amount of UV additive does not exceed a limit that will cause the overall coating to fail. As such, the UV additive should not be added at amounts more than about 40% by weight of the coating composition.

In some embodiments, after curing, the final UV additive amount in the cured coating is from about 0.2% to about 60%, by weight, of the cured coating. Though the amount of additives added to the coating composition should not exceed about 40%, because the coating compositions may include, for example, volatiles that will evaporate during curing, in some embodiments the finished coating will have a higher concentration, by weight, of the cured UV additives than in the coating composition.

The coating compositions of the present disclosure may also contain a structural component (e.g., polymer resin and/or ceramic material) through which the at least one additive is dispersed. In this regard, it should be noted that the at least one additive need not be uniformly dispersed throughout the structural component and there may be localized concentrations that are higher or lower than the average concentration in the coating composition and use of the term “dispersed” should not be considered in a limiting sense.

In some embodiments, the coating composition is a sol-gel composition, which can be formed using methods generally known in the art. In some embodiments, when the UV cured additive is added to the a mixture with the formulation to form the coating composition, the resulting coating composition is in the liquid state.

In some embodiments, the at least one additive is dispersed throughout a base resin. The base resin may comprise a fluoropolymer such as, for example, polytetrafluoroethylene, perfluoroalkoxy, fluorinated ethylene propylene and mixtures thereof; however, it should be understood that other polymers including polymers other than fluoropolymers may be used without limitation. The fluoropolymers act to reduce the friction of the coating of the personal care apparatus such that the personal grooming apparatus is suitable for use in hair grooming. The fluoropolymers may be silicone modified (i.e., a co-polymer with silicone functionality may be incorporated into the fluoropolymer) which allows the coating to be more durable and to better withstand temperature extremes. The amount of fluoropolymer resin that is used in the coating composition may be at least about 20 wt %, at least about 40 wt % or at least about 50 wt % (e.g., from about 20 wt % to about 85 wt %, from about 40 wt % to about 85 wt % or from about 50 wt % to about 70 wt %).

The coating composition may also optionally contain one or more ceramics (e.g., silica, alumina, titania or silicon carbide). When combined with fluoropolymers, the ceramic materials allow the coating to be sufficiently hard after processing (e.g., curing). When the coating composition contains ceramics, the ceramics are generally combined with the fluoropolymer resin; however, in certain embodiments, the ceramics are used without any amount of fluoropolymer resin and the ceramics themselves give the coating its basic structure. When combined with a fluoropolymer, the amount of ceramics in the composition may be at least about 1 wt % and, in other embodiments, at least about 3 wt % or at least about 5 wt % (e.g., from about 1 wt % to about 15 wt % or from about 1 wt % to about 10 wt %). When the coating composition does not contain fluoropolymer resins, the amount of ceramic material in the coating composition may be at least about 30 wt %, at least about 50 wt % or even at least about 70 wt % (e.g., from about 30 wt % to about 90 wt %, from about 40 wt % to about 80 wt % or from about wt % to about 80 wt %). In some embodiments, the coating composition does not contain ceramic material.

Other functional components may be included in the coating composition without departing from the scope of the present disclosure. For instance, the coating composition may optionally include one or more colorants, binders, dispersants, sintering aids, plasticizers, antimicrobials (e.g., nano silver or nano titanium dioxide), hardeners (e.g., nanodiamond) and the like.

The coating composition may include one or more coloring agents (i.e., “colorants”) that modify the appearance of the coating. Examples of such colorants include mica powder and various color pigments. The amount of colorants in the coating composition may range from about 0.01 wt % to about 20 wt % (e.g., from about 0.5 wt % to about 15 wt % or from about 3 wt % to about 15 wt %).

Generally, the binder alters the rheology of the coating composition and maintains the distribution of particles in the solution throughout application and curing. Suitable binders for use in the coating composition include polyvinyl butyral which may be present in an amount of at least about 0.5 wt % (e.g., 0.5 wt % to about 20 wt % or from about 1 wt % to about 10 wt %).

The coating composition may optionally include a dispersant that acts to prevent any particulate (e.g., ceramics) from settling prior to application of the coating composition to the substrate. The dispersant may be present in an amount of at least about 0.05 wt % (e.g., from about 0.05 wt % to about 10 wt %, from about 0.1 wt % to about 7.5 wt % or from 0.5 wt % to about 5 wt %). One suitable dispersant for use in the composition is a methyloxirane polymer.

A plasticizer may also be included in the composition. The plasticizer may be chosen to allow the coating composition to dry without cracking. The plasticizer may be present in an amount of at least about 0.5 wt % (e.g., 0.5 wt % to about 20 wt % or from about 1 wt % to about 10 wt %). One suitable plasticizer is polyethylene glycol.

The coating composition generally includes a “medium” or “carrier” in which the coating components are applied to the substrate. For instance, the medium may be a solvent in which one or more coating composition components at least partially dissolves. In this regard, it should be understood that while the term “solvent” is used herein, some of the composition components (e.g., ceramics) remain substantially in particulate form throughout the solvent. Thus, the solvent may also be referred to as a “diluent” in which the particulate components are suspended. For purposes of the present disclosure, the terms “medium,” “carrier,” “diluent,” and “solvent” may be used interchangeably and are not meant to limit embodiments of the present disclosure to compositions wherein one or more components do or do not dissolve.

Suitable solvents include organic compounds such as, for example, C1 to C10 alcohols, methyl ethyl ketone, acetone, petroleum distillates and combinations of these compounds. The amount of solvent may vary according to the desired flowability of the coating composition. In some embodiments of the present disclosure, the coating composition contains at least about 5 wt % solvent (or solvents when more than one solvent is used) and, in other embodiments, at least about 10 wt % or even about 20 wt % solvent (e.g., from about 5 wt % to about 40 wt % or from about 5 wt % to about wt % solvent). Preferably the solvent vaporizes readily during any drying steps. The composition may include more than one solvent with the total weight fraction of solvents in the composition being as described above.

Water is generally not used as a solvent when fluoropolymer resins are included in the composition as water in some instances may be immiscible with fluoropolymers. However, when fluoropolymers are not used (e.g., ceramics are used as the primary coating material), water may be used as a solvent and, optionally, may be combined with one or more organic solvents.

In one or more embodiments of the present disclosure, the coating composition containing the UV cured additive is applied to a base coating that is disposed on the substrate. Similar to the top coating, the base coating may contain fluoropolymers and ceramics (e.g., silica, titania, zirconia, and chromic (III) oxide). The base coating may also contain other additives such as barium sulfate that improve the rheological properties of the coating and, optionally, binders, dispersants, sintering aids, plasticizers and the like. These components may be included in the base composition in the same amounts as described above for the UV cured additive coating. The base coating optionally does not contain UV cured additives as the UV cured additive coating is disposed on its surface; however, the base coating may contain such additives without departing from the scope of the present disclosure.

Personal Care Apparatus

In accordance with the present disclosure, in some embodiments a personal grooming apparatus for grooming hair is disclosed. The apparatus comprises a substrate and a coating composition disposed on the substrate, wherein the coating composition comprises at least one additive that has been cured under UV light. In some embodiments of the present disclosure, the substrate comprises a polymer or a metal.

In some embodiments, the personal care apparatus is selected from the group consisting of a hair straightener, a curling iron, a hair brush, a comb and a hair dryer. When the apparatus is a hair straightener, in some embodiments, the substrate is at least one plate of the hair straightener. In some embodiments, the plates are heated plates. In other embodiments, when the apparatus is a curling iron, the substrate is a barrel of the curling iron. In still other embodiments, when the apparatus is a curling iron, the coating composition is applied to at least one clip of the curling iron. In yet other embodiments, when the apparatus is a hair dryer, the substrate is a grill of the hair dryer. Thus, in various embodiments of the present disclosure, the coating composition is applied to at least one plate of a hair straightener, a barrel of a curling iron, at least one clip of a curling iron or a grill of the hair dryer. It is to be understood, however, that the coating composition may also be applied to other parts of these apparatuses without departing from the scope of the present disclosure.

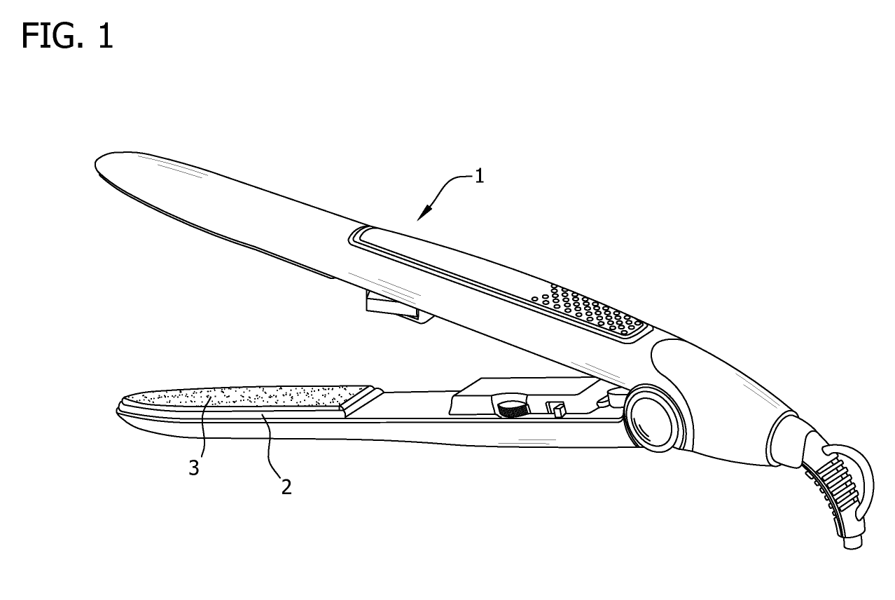

Referring now to FIG. 1, an exemplary embodiment of a hair straightener 1 in accordance with the present disclosure is shown. The straightener 1 contains a heating plate 2 with a UV cured coating composition 3 of the present disclosure disposed thereon.

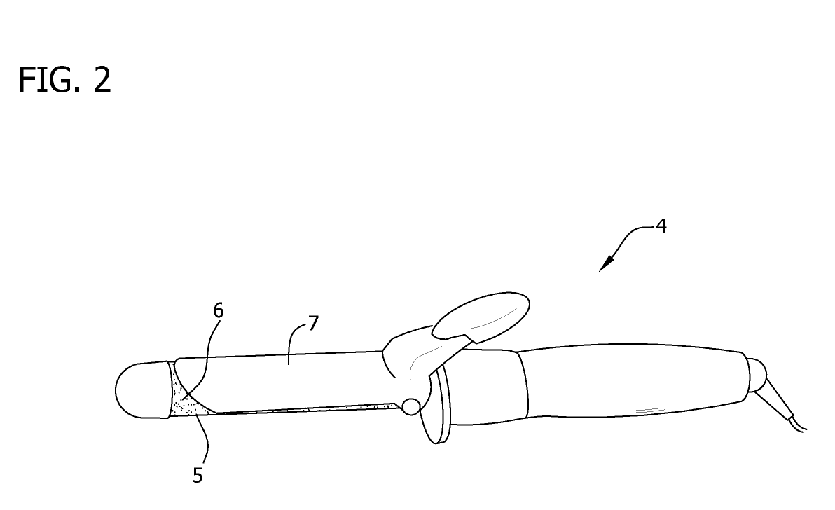

Another exemplary embodiment of a personal grooming apparatus in accordance with the present disclosure is a hair curling iron 4 shown in FIG. 2. The curling iron 4 includes a barrel 5. A UV cured coating composition 6 of the present disclosure may be disposed on the barrel 5. A UV cured coating composition (not shown) may also be applied to the underside of the clip 7.

### Methods for Applying the Coating Compositions of the Present Disclosure

The substrate materials to which the UV cured coating compositions of the present disclosure are applied may be subjected to one or more surface preparation procedures before the coating composition is applied. For instance, the surface may be cleaned by rinsing in water or in a dilute cleaning solution that is compatible with the substrate (e.g., a solution of trichloroethylene or other degreasing solution). The surface of the substrate may also be smoothed by conventional surface roughness reduction techniques (e.g., sand or alumina blasting) to remove any surface roughness that may extend through the coating. Sand or alumina-blasting may also be performed to assist in adhesion of the coating composition to the substrate. The coating composition may be subjected to a filtering operation (e.g., screening) before application of the coating composition so as to remove undesirable larger particles (e.g., particles greater than about 30 μm or greater than about 75 μm in size).

The coating composition may generally be applied to the substrate by any of the methods known to those of ordinary skill in the art. Suitable methods include spray coating, immersion, brushing and powder coating techniques. Conventional spray coating methods may be used including air, air-assisted, airless and electrostatic atomization. Air Atomization may be performed under high-volume, low pressure conditions, such as pressures below about 35 MPa. It should be noted that when powder coating techniques are used, the coating composition does not contain solvents and no curing step is performed. Generally, the coating composition is a powder that has the same chemical composition of the coating itself. Powder coating techniques known to those of skill in the art may be used in accordance with the present disclosure.

As described above, the UV cured coating composition may be applied to the surface of a base coating that is disposed on the surface of the substrate. The base coating may be formed by the methods described above relating to application of the UV cured coating composition. In some embodiments, the base coating is formed by spraying a base coating composition to the substrate and curing the composition (e.g., to at least about 140° C.). The base coating may be cured before application; however, in some embodiments of the present disclosure, the top coating is applied to the base coating before any curing operations and the base coating and top coating compositions are cured at once (i.e., wet-on-wet coating).

In embodiments wherein a single coating is applied to the substrate of the personal grooming apparatus (i.e., when a base coating is not used), the coating composition may be applied such that the coating as cured has a thickness of at least about 1 μm, at least about 5 μm, at least about 25 μm, at least about 50 μm or at least about 150 μm (e.g., from about 5 μm to about 500 μm, from about 8 μm to about 60 μm or from about 15 μm to about 30 μm).

When multiple coatings are applied (e.g., a base coat applied to the surface of the substrate with a UV cured coating applied thereto), the total thickness of the coatings applied to the substrate are generally within the ranges described above. In various embodiments, the UV cured coating (which is typically the surface coating) may have a thickness of less than about 100 μm, less than about 50 μm, or less than about 20 μm (e.g., from about 3 μm to about 100 μm, from about 3 μm to about 20 μm or from about 10 μm to about 20 μm). In some embodiments, the base coating is thicker than the UV cured coating (e.g., from about 5 μm to about 50 μm thicker). The thickness of the base coating may be less than about 150 μm, less than about 75 μm, less than about 40 μm or less than about 30 μm (e.g., from about 10 μm to about 150 μm, from about 3 μm to about 30 μm or from about 15 μm to about 30 μm). In this regard, other thicknesses may be used without departing from the scope of the present disclosure and the recited ranges should not be viewed in a limiting sense.

When introducing elements of the present disclosure or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above apparatus and methods without departing from the scope of the disclosure, it is intended that all matter contained in the above description and shown in the accompanying figures shall be interpreted as illustrative and not in a limiting sense.

What is claimed is:

1. A method for manufacturing a personal care apparatus for grooming hair, the method comprising:
curing at least one additive under ultraviolet (UV) light,
mixing the at least one cured additive into a formulation to form a coating composition; and,
applying the coating composition to a substrate of the apparatus.

2. The method of claim 1, wherein the coating composition comprises from about 0.1% to about 40% by weight of the at least one additive.

3. The method of claim 1, wherein the at least one additive comprises titanium dioxide.

4. The method of claim 1, wherein the UV light has a wavelength of from about 100 nm to about 400 nm.

5. The method of claim 1, wherein the personal care apparatus is selected from the group consisting of a hair straightener, a curling iron, a hair brush, a comb and a hair dryer.

6. The method of claim 1, wherein the at least one additive is cured for at least about 5 minutes.

7. The method of claim 1, wherein the at least one additive is cured at a power of at least about 5 W/m².

8. A method for manufacturing a personal care apparatus for grooming hair, the method comprising:
applying a coating composition to a substrate of the apparatus, the composition comprising at least one additive; and,
curing the coating composition under ultraviolet (UV) light.

9. The method of claim 8, wherein the coating composition comprises from about 0.1% to about 40% by weight of the at least one additive.

10. The method of claim 8, wherein the at least one additive comprises titanium dioxide.

11. The method of claim 8, wherein the UV light has a wavelength of from about 100 nm to about 400 nm.

12. The method of claim 8, wherein the personal care apparatus is selected from the group consisting of a hair straightener, a curling iron, a hair brush, a comb and a hair dryer.

13. The method of claim 8, wherein the coating composition is cured at a power of at least about 5 W/m².

14. A personal grooming apparatus for grooming hair, the apparatus comprising a substrate and a coating composition disposed on the substrate, wherein the coating composition comprises at least one additive that has been cured under ultraviolet (UV) light.

15. The apparatus of claim 14, wherein the coating composition comprises from about 0.1% to about 40% by weight of the at least one additive.

16. The apparatus of claim 14, wherein the at least one additive comprises titanium dioxide.

17. The apparatus of claim 14, wherein the UV light has a wavelength of from about 100 nm to about 400 nm.

18. The apparatus of claim 14, wherein the apparatus is selected from the group consisting of a hair straightener, a curling iron, a hair brush, a comb and a hair dryer.

19. The apparatus of claim 14, wherein the coating composition comprises a base resin.

20. The apparatus of claim 14, wherein the coating composition comprises a ceramic material.
